(19) United States
(12) Patent Application Publication
(10) Pub. No.: US 2019/0188942 A1
(43) Pub. Date: Jun. 20, 2019

(54) REFRIGERATION SYSTEM

(71) Applicant: Clockon Investments Pty Limited, Mermaid Beach (AU)

(72) Inventor: Peter Thompson, Mermaid Beach (AU)

(21) Appl. No.: 16/327,764

(22) PCT Filed: Aug. 24, 2017
(86) PCT No.: PCT/AU2017/050898

§ 371 Date: Feb. 22, 2019

(30) Foreign Application Priority Data
Aug. 24, 2016 (AU) 2016903368

(51) Int. Cl. G07F 13/10; F25D 25/02

(52) U.S. Cl. CPC G07F 13/10; F25D 25/02

(57) ABSTRACT

A refrigeration system having a housing which houses at least one dispenser for storing and dispensing packaged beverages and fluid disperser. The dispenser includes a loading end, a dispensing end and a travel path extending from the loading end to the dispensing end, wherein the dispensing end is positioned lower than the loading end. The fluid disperser disperses a fluid over at least a portion of the travel path of the dispenser.

### FIELD OF THE INVENTION

The invention relates to a refrigeration system. In particular, the invention relates, but is not limited, to a refrigeration system for cooling and dispensing packaged beverages.

### BACKGROUND TO THE INVENTION

Reference to background art herein is not to be construed as an admission that such art constitutes common general knowledge.

Various types of portable refrigeration units have been designed to enable persons to keep food items such as canned beverages handy while traveling and engaging in various outdoor activities where a traditional electric refrigerator is not available.

In many cases, the portable refrigeration unit was simply an insulated container that may or may not be refrigerated by refrigerating means. Examples of such cooling means can include ice, various cold packs containing a chillable or freezable liquid, and various thermoelectric cooling means which require constant electrical input. These cooling means rely primarily on gas, typically air, as a medium for heat transfer, which is inefficient and can take large amounts of time or electrical energy to cool the contents of the unit rapidly.

Furthermore, a large portion of the chilled air inside of a cooler is lost due to the influx of ambient air each time that the door of the unit is opened.

Since it is often desirable to provide an abundance of cool beverages during events such as sporting and leisure events, it would be beneficial to provide a design especially for dispensing a packaged beverage with a minimum loss of cooled air upon dispensing while also maximising the storage capacity and cooling efficiency of items, particularly beverages packaged in cylindrical cans.

Furthermore, at sporting events, it is not unusual for large quantities of beverages to be sold, necessitating the restocking and cooling of beverages. Thus, it is beneficial to provide a way to cool large quantities of beverages very quickly.

### OBJECT OF THE INVENTION

It is an aim of this invention to provide a refrigeration system which overcomes or ameliorates one or more of the disadvantages or problems described above, or which at least provides a useful alternative.

Other preferred objects of the present invention will become apparent from the following description.

### SUMMARY OF THE INVENTION

In one form, although it need not be the only or indeed the broadest form, there is provided a refrigeration system comprising:

a housing including:
at least one dispenser for storing and dispensing packaged beverages, the dispenser including a loading end, a dispensing end and a travel path extending from the loading end to the dispensing end, wherein the dispensing end is positioned lower than the loading end; and
a fluid disperser within the housing, the fluid disperser dispersing a fluid over at least a portion of the travel path of the dispenser within the housing.

Preferably, the refrigeration system further comprises a cooling unit configured to cool the fluid. Preferably, the cooling unit cools the interior of the housing. Preferably, the cooling unit is a refrigerating device. More preferably, the refrigerating device comprises a compressor, condenser coils and evaporator coils.

Preferably the cooling unit is configured to cool the fluid to between about 0° C.-10° C., and more preferably to between about 0° C. and 5° C. Even more preferably to around 1° C.

Preferably the fluid is water. The refrigeration system preferably comprises a water inlet configured to receive water for use therein. The refrigeration system may comprise a water outlet configured to drain after use. Alternatively, the refrigeration system is a closed loop system.

Preferably, the housing includes at least one opening. More preferably, the housing includes at least two openings. Preferably, at least one opening is adjacent the dispensing end of the dispenser. Preferably, at least one opening is adjacent the loading end of the dispenser. Preferably, each of the at least one openings includes a door. Preferably, the door is hinged. Preferably, the door is removable.

Preferably, the dispensing end of the dispenser includes a stop to prevent packaged beverages from falling out of the housing.

Preferably, the dispenser includes two opposing walls for guiding and preventing canned beverages from falling off the travel path. Preferably, the opposing walls are spaced sufficiently to allow a single packaged beverage, such as a can or bottled drink, to travel along the travel path in single file.

Preferably, the travel path includes an aperture extending along a length of the travel path. Preferably, the travel path has a winding path defining a plurality of levels. Preferably, the winding path includes about 2 to 5 levels. Preferably, the plurality of levels of the winding path include a plurality of inclined racks. Preferably, the plurality of inclined racks are arranged in a zig-zag formation. Preferably, the at least one dispenser is gravity fed. Alternatively, or additionally, the at least one dispenser includes a conveyor.

Preferably, the fluid disperser includes at least one pipe. Preferably, the at least one pipe includes at least one outlet for dispersing water within the housing. Preferably, the outlet is a sprinkler or misting outlet. Preferably, the at least one pipe extends along a ceiling of the housing. Preferably, the at least one pipe extends from a floor of the housing to a ceiling of the housing. Preferably, at least one pipe extends between the inclined racks to provide better fluid saturation and faster cooling of the packaged beverages. More preferably, at least one pipe of the fluid disperser is located between two adjacent racks of the travel path.

Preferably, the fluid disperser recycles water from the bottom of the housing. Preferably, the disperser includes a pump for pumping the recycled water from the bottom of the housing to the pipes and outlets.

Preferably, the travel path comprises at least a portion that is at an incline to a horizontal axis. Preferably, the incline of the travel path is between about 1°-45°. More preferably, the incline of the travel path is between about 2°-20°. Even more preferably, the incline of the travel path is between about 5°-10°.

Preferably, the refrigeration system is powered by a generator that is at least one of solar powered, battery powered and diesel powered. Preferably, the refrigeration system may be connected to a mains electricity supply.

Preferably, the housing includes at least one internal light. Preferably, the internal light is protected against the ingress of water.

Preferably, the housing includes at least one external light. Preferably, the external light is protected against the ingress of water and dust.

Preferably, the housing includes at least two wheels for transporting the refrigeration system. More preferably, the housing includes four wheels.

Preferably, an exterior of the housing comprises metal. More preferably, the exterior of the housing comprises aluminium.

Preferably, an interior of the housing comprises metal. More preferably, the exterior of the housing comprises aluminium.

Preferably, the interior of the housing comprises plastic.

Preferably, the housing comprises an insulating layer between the exterior and the interior. Preferably, the insulating layer comprises fiberglass or an insulating foam.

In another form, there is provided a method of refrigerating packaged beverages comprising:

loading packaged beverages into a gravity fed dispenser located within a housing, wherein the dispenser includes a loading end, a dispensing end and a travel path extending from the loading end to the dispensing end, wherein the dispensing end is positioned lower than the loading end;

conveying beverages along the travel path; and

dispersing a cooled fluid within the housing to cool the packaged beverages in the travel pat.

Preferably, the method further comprises the step of cooling the fluid with a refrigerating device. Preferably, the method further comprises the step of cooling an interior of the housing with a cooling or refrigerating device. Preferably the method comprises using a refrigeration system as hereinbefore described.

### BRIEF DESCRIPTION OF THE DRAWINGS

By way of example only, preferred embodiments of the invention will be described more fully hereinafter with reference to the accompanying figures, wherein:

FIG. 1 illustrates a front view of a refrigeration system according to an embodiment of the present invention;

FIG. 2 illustrates a side view of the refrigeration system illustrated in FIG. 1;

FIG. 3 illustrates an alternative side view of the refrigeration system illustrated in FIG. 1 showing a stop;

FIG. 4 illustrates an interior view of the refrigeration system illustrated in FIG. 1;

FIG. 5 illustrates an interior view of the refrigeration system illustrated in FIG. 1 dispersing water; and

FIG. 6 illustrates a view of a cooling system for cooling the interior of the housing and the water.

### DETAILED DESCRIPTION OF THE DRAWINGS

The following detailed description relates to a preferred embodiment of the invention illustrated in the drawings, and it should be appreciated that it is not to be regarded as limiting.

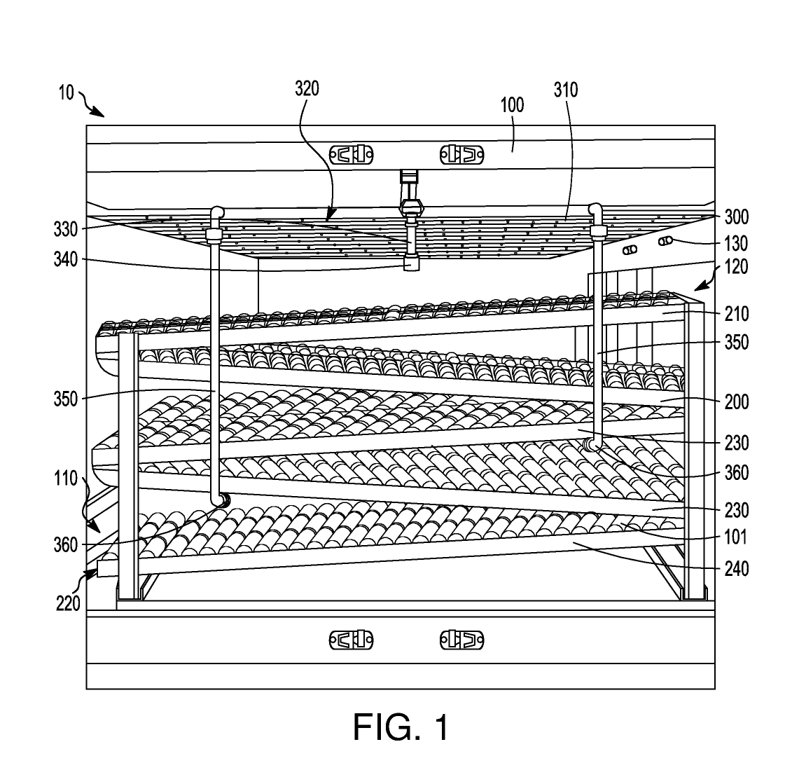

FIG. 1 illustrates a front view of an internal refrigeration system 10 for cooling and dispensing packaged beverages, such as canned beverages 101 and bottled beverages (not shown). The refrigeration system 10 has a housing 100, a plurality of gravity fed dispensers 200 and a water delivery system 300. The gravity fed dispensers 200 and the water delivery system 300 are housed within the housing 100.

The housing 100 is a substantially rectangular insulated body constructed from metal, such as aluminium, for example or plastic, for storage and dispensing canned beverages 101 through a dispensing outlet 110. The dispensing outlet 110 is located on a side of the housing 100 and allows customers and servers to easily access the canned beverages for dispensing. The housing 100 can be insulated by a fibreglass layer (not shown) between the interior and exterior of the housing 100.

The housing 100 also includes a loading opening 120 to allow a user to load canned beverages 101 into the refrigeration system 10.

As shown, the housing 100 contains a plurality of gravity fed dispensers 200 for storing and providing canned beverages 101 to dispensing outlet 110. The gravity fed dispenser 200 includes a loading end 210 and a dispensing end 220. Extending between the loading end 210 and the dispensing end 220 is a winding travel path defined by a series of inclined racks 230 defining multiple levels in a zig-zag formation.

The racks 230 extend horizontally from one side of the housing 100 to the opposing side in a winding path beginning at the loading end 210 and finishing at the dispensing end 220 of the dispenser 200.

The racks 230 each have a minimum incline to the horizontal such that a canned beverage 101 moves along the rack 230 toward the dispensing end 220 in response to a gravitational force. As shown in FIG. 1, the angle of the racks 230 can be a substantially small angle. However, the inclination of the racks 230 can be anywhere between 1°-45°.

The racks 230 of the dispenser 200 include opposing side walls 240 separated by an aperture which improves air circulation around the canned beverages 101. The opposing side walls 240 guide and prevent canned beverages 101 from falling off the rack 230.

While the dispenser 200 is described as gravity fed, it will be appreciated that the dispenser 200 can include a mechanical conveyor for conveying beverages along the racks 230.

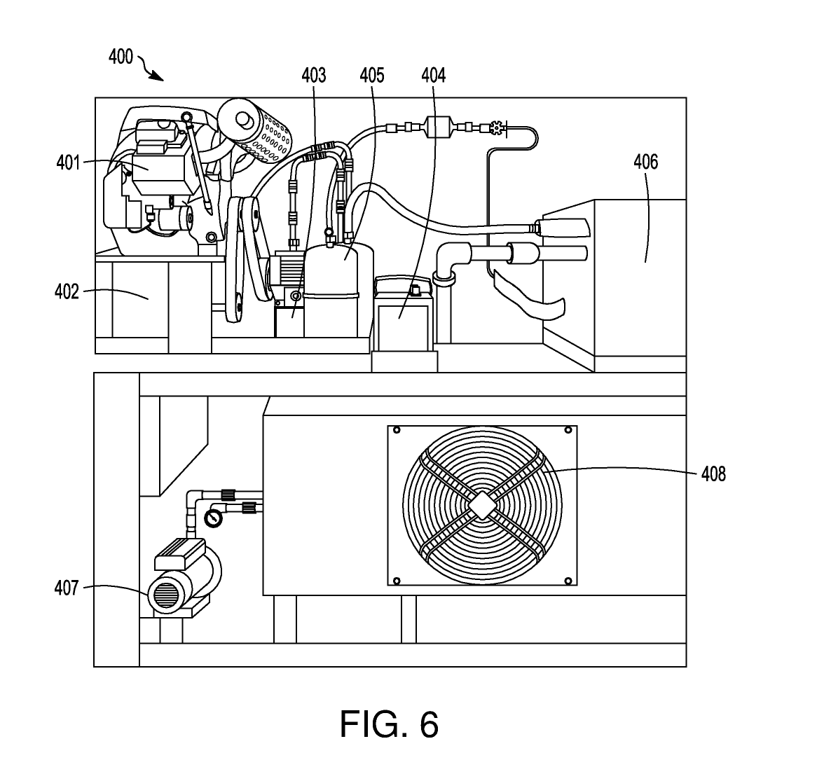

The water delivery system 300 is defined by a sprinkler type system that is mounted along the top of the housing 100. The water delivery system 300 is provided with a cooled fluid, such as water, from a cooling or refrigerating unit (shown in FIG. 6) which typically cools the fluid to around 1° C. (but could cool the fluid to anywhere between 0° C. to 10° C.) and can assist in cooling the interior of the housing 100. The refrigerating unit can be a typical unit found in refrigerators comprising a compressor, condenser coils and evaporator coils. However, it will be appreciated by a person skilled in the art that other methods and devices for cooling can be used.

While not shown, the refrigerating unit may include a water inlet to receive water and a water outlet to drain the water from the refrigerating unit after use. The refrigerating unit may alternatively be a closed loop system.

As shown, the system 300 includes a plurality of pipes 310 and outlets 320 for delivering the water. The pipes 310 illustrated in FIG. 1 run parallel to the racks 230. However, the pipes 310 can also run transverse to the racks 230.

Located at an end of the housing 100 is a large opening 330 for delivering larger amounts of cooled water at a higher rate. As shown, the system 300 includes a control mechanism in the form of a rotatable mechanism 340 for controlling the flow of the cooled water.

Additionally, the pipes 310 can run along the interior walls of the housing 100 to provide greater water saturation and coverage, and to increase the cooling effect.

Further additional pipes 350 and outlets 360 may also extend between the racks 230 to provide better saturation and faster cooling of the canned beverages 101 located towards the dispensing end 220.

During operation, the housing is sealed and cooled water is delivered to the pipes 310 of the sprinkler system 300 and dispersed in a spray or mist to cover the canned beverages 101 in the cooled water. As more cooled water is dispersed, the cooled water trickles down from the canned beverages 101 at the top of the housing 100 to the canned beverages 101 at the bottom of the housing 100.

Once the cooled water reaches the floor of the housing 100 it is then recycled, re-cooled and dispersed through the pipes 310 and sprinkler outlets 320 which spray the water over the canned beverages 101 to further cool the canned beverages 101.

To provide improved visibility of the contents within the housing 100, interior lights 130 can be installed within the housing 100.

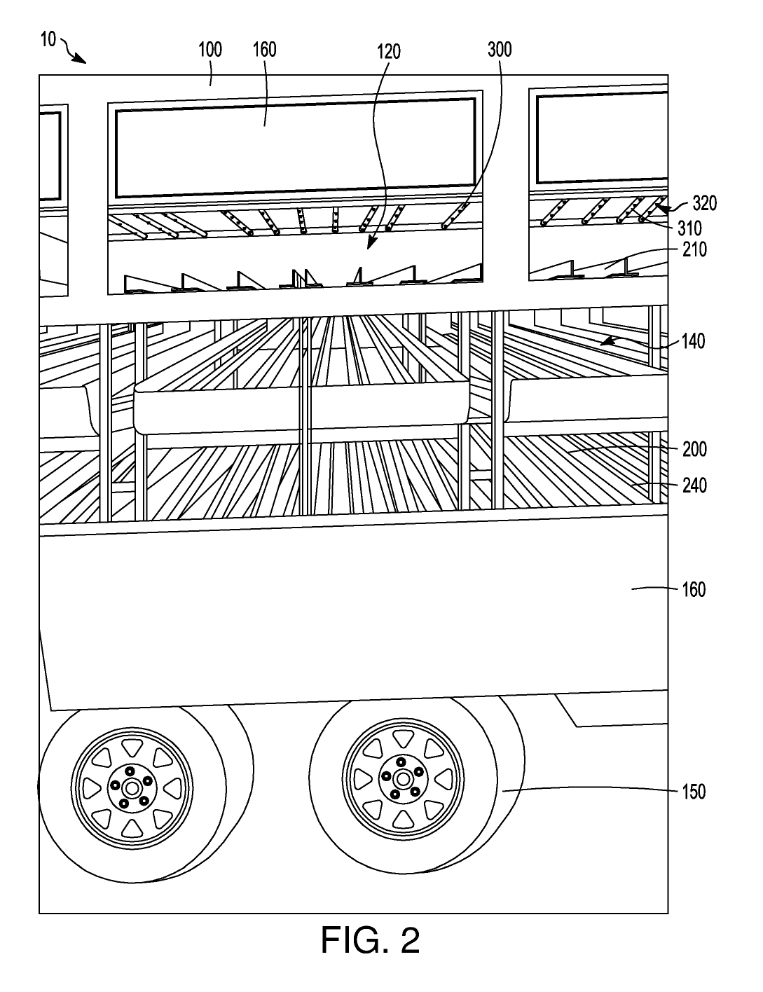

Referring to FIG. 2 which illustrates a side view of the refrigeration system 10 shown in FIG. 1, the housing 100 can include multiple openings 120, 140 for loading and dispensing canned beverages (not shown).

Further illustrated in FIG. 2 are wheels 150 fitted to the housing 100 to improve the portability of the refrigeration system 10. By including wheels 150, the refrigeration system 10 can be transported to different venues and locations to cater for multiple events, such as shows/carnivals, fairs, sporting events and festivals. While illustrated as a portable and transportable system, refrigeration system 10 can also be a fixed installation. For example, the refrigeration system 10 can be installed at a sporting stadium replacing standard refrigeration systems.

As shown, the side walls 240 are spaced sufficiently to allow a single can laid horizontally to travel along the rack 230. However, a person skilled in the art will appreciate that the walls can be spaced sufficiently to allow any number of cans, or any other type of packaged beverage such as bottled drinks, to travel along the rack side by side.

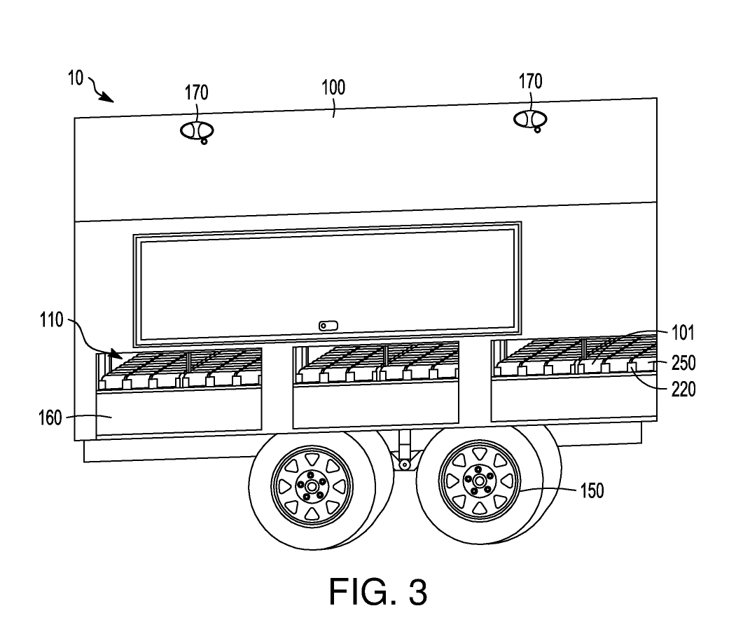

With reference to FIG. 3, a stop 250 is formed at a lowest extent of the gravity fed dispenser 200. The stop 250 engages the canned beverage 101 to prevent unwanted further movement along the rack 230 and positions the canned beverage 101 for viewing and selection by a customer through the dispensing outlet 110.

Referring to FIGS. 2 and 3, the outlet 110 and opening 120 are of a sufficient size to allow packaged beverages to be loaded and removed from the system 10 without the need for large doors to allow access to every product contained within. Further, the outlet 110 and opening 120 can be opened and closed as needed through the use of one or more hinged doors 160.

To enhance visibility of the packaged beverages 101, external lights 170 are provided on the exterior of the housing 100.

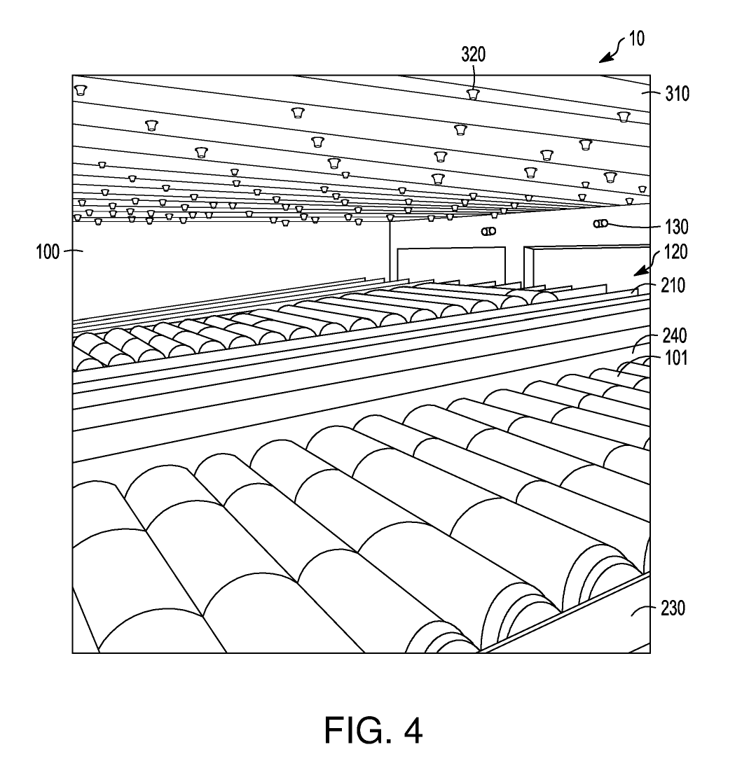

Turning to FIG. 4, the pipes 310 can be seen to include water dispersing outlets 320. These outlets 320 disperse cooled water in a spray or mist that covers the warm canned beverages 101.

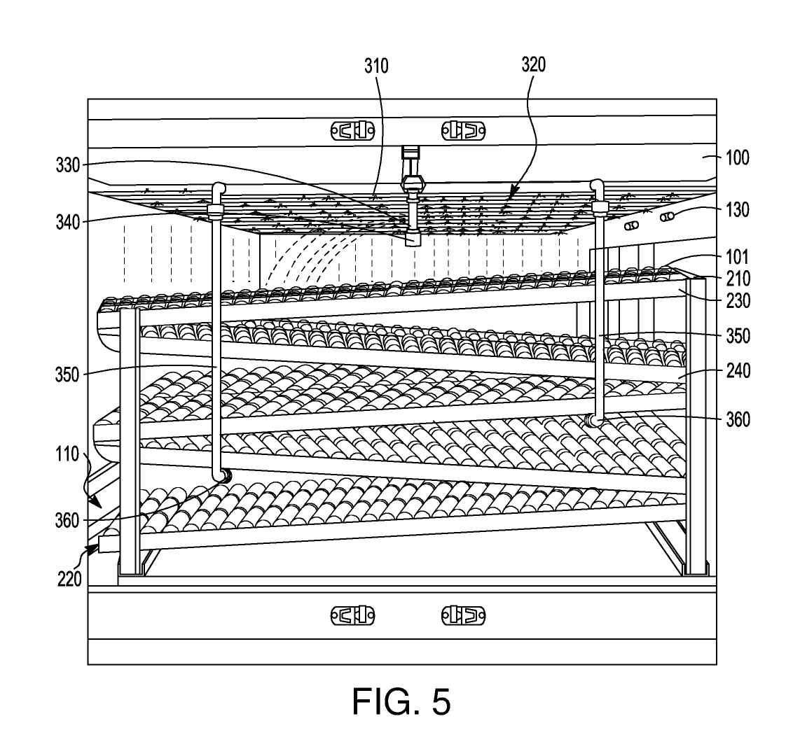

FIG. 5 shows the water disperser system 300 in use. As shown, water is sprayed from the outlets 320 such that the canned beverages 101 are covered in the cooled water.

Referring to FIG. 6, there is illustrated a cooling system 400 for cooling the interior of the housing and the water dispersed through the dispersing system. As shown, the cooling system 400 includes typical components such as a motor 401, generator 402, compressor 403, battery 404, chiller unit 406, fan 408, pump 407 and oil mixers 405 to achieve sufficient temperatures to cool the packaged beverages within the housing. The generator 402 can be any type of generator including, but not limited to, at least one of a solar powered generator, a battery powered generator and a diesel powered generator.

Advantageously, liquids provide a better medium for heat transfer than gas and thus the canned beverages can be cooled faster than in a typical refrigerator.

Further advantageously, the present invention provides an optimum combination of high storage capacity and improved cooling means.

Another advantage of the refrigeration system is that cooling time can be significantly reduced. In some instances, up to 250 cans can be cooled in an hour.

In a further advantage, in some embodiments, the refrigeration system can be transported to various venues and locations to cater for multiple events, such as shows/carnivals, fairs, sporting events and festivals.

Further advantageously, the refrigeration system can also be a fixed installation. For example, the refrigeration system can be installed at a sporting stadium to replace standard refrigeration systems.

Further advantageously, the opening for loading and dispensing can be sized sufficiently to allow beverages to be inserted and removed while minimising the amount of cold air lost to the atmosphere.

In this specification, adjectives such as first and second, left and right, top and bottom, and the like may be used solely to distinguish one element or action from another element or action without necessarily requiring or implying any actual such relationship or order. Where the context permits, reference to an integer or a component or step (or the like) is not to be interpreted as being limited to only one of that integer, component, or step, but rather could be one or more of that integer, component, or step etc.

The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. The invention is intended to embrace all alternatives, modifications, and variations of the present invention that have been discussed herein, and other embodiments that fall within the spirit and scope of the above described invention.

In this specification, the terms ‘comprises’, ‘comprising’, ‘includes’, ‘including’, or similar terms are intended to mean a non-exclusive inclusion, such that a method, system or apparatus that comprises a list of elements does not include those elements solely, but may well include other elements not listed.

What is claimed is:

1. A refrigeration system comprising:
a housing including:
at least one dispenser for storing and dispensing packaged beverages, the at least one dispenser including a loading end, a dispensing end and a travel path extending from the loading end to the dispensing end, wherein the dispensing end is positioned lower than the loading end; and
a fluid disperser within the housing, the fluid disperser dispersing a fluid over at least a portion of the travel path of the at least one dispenser within the housing.

2. The refrigeration system as claimed in claim 1 further comprising a cooling unit configured to cool the fluid.

3. The refrigeration system as claimed in claim 2, wherein the cooling unit is configured to cool the fluid to between about 0° C.-10° C.

4. The refrigeration system as claimed in claim 3, wherein the cooling unit is further configured to cool the interior of the housing.

5. The refrigeration system as claimed in claim 1, wherein the housing includes at least two openings for loading and unloading packaged beverages.

6. The refrigeration system as claimed in claim 1, wherein the fluid disperser includes at least one pipe extending along a ceiling of the housing.

7. The refrigeration system as claimed in claim 1, wherein each of the pipes includes at least one outlet for dispersing water within the housing.

8. The refrigeration system as claimed in claim 7, wherein each of the at least one outlets is a sprinkler outlet for spraying the fluid within the housing.

9. The refrigeration system as claimed in claim 1, wherein each of the at least one dispenser includes two opposing walls for guiding and preventing packaged beverages from falling off the travel path.

10. The refrigeration system as claimed in claim 1, wherein the travel path includes at least a portion that is at an incline to a horizontal axis.

11. The refrigeration system as claimed in claim 1, wherein the travel path has a winding path having a plurality of inclined racks.

12. The refrigeration system as claimed in claim 10, wherein the incline of the travel path is between about 1°-45°.

13. The refrigeration system as claimed in claim 11, wherein the winding path has 5 inclined racks.

14. The refrigeration system as claimed in claim 6, wherein the fluid disperser includes the at least one pipe extending between two of the plurality of inclined racks.

15. The refrigeration system as claimed in claim 1, wherein the refrigeration system is powered by a generator that is at least one of a solar powered generator, a battery powered generator and a diesel powered generator.

16. The refrigeration system as claimed in claim 1, wherein the housing is a mobile housing including two or more wheels for transporting the refrigeration system.

17. The refrigeration system as claimed in claim 1, wherein the housing includes an interior, an exterior and an insulating layer located between the interior and the exterior.

18. A method of refrigerating packaged beverages, the method comprising:
loading packaged beverages into a gravity fed dispenser located within a housing, wherein the gravity fed dispenser includes a loading end, a dispensing end and a travel path extending from the loading end to the dispensing end, wherein the dispensing end is positioned lower than the loading end;
conveying beverages along the travel path; and
dispersing a cooled fluid within the housing to cool the packaged beverages in the travel path.

19. The method of claim 18 further comprising cooling an interior of the housing with a cooling unit.

20. The method of claim 19 further comprising cooling the fluid with the cooling unit.
